(19) United States
(12) Patent Application Publication
(10) Pub. No.: US 2017/0091948 A1
(43) Pub. Date: Mar. 30, 2017

(54) METHOD AND SYSTEM FOR AUTOMATED ANALYSIS OF CELL IMAGES

(71) Applicant: Konica Minolta Laboratory U.S.A., Inc., San Mateo, CA (US)

(72) Inventors: Foram Manish PARADKAR, San Jose, CA (US); Yongmian ZHANG, Union City, CA (US); Jingwen ZHU, Foster City, CA (US); Haisong GU, Cupertino, CA (US)

(73) Assignee: Konica Minolta Laboratory U.S.A., Inc., San Mateo, CA (US)

(21) Appl. No.: 15/253,324

(22) Filed: Aug. 31, 2016

Related U.S. Application Data
(60) Provisional application No. 62/235,076, filed on Sep. 30, 2015.

(51) Int. Cl. G06T 7/00; G06K 9/52; G06K 9/62; G06T 7/60; G06K 9/66; G06K 9/46

(52) U.S. Cl. CPC G06T 7/0081; G06K 9/66; G06T 7/0085; G06K 9/4604; G06K 9/6267; G06T 7/60; G06K 9/52; G06T 7/0002; G06K 9/4671; G06T 7/0042; G06K 2009/4666; G06T 2207/20144

(57) ABSTRACT

A method, a computer readable medium, and a system are disclosed for cell segmentation. The method including generating a binary mask from an input image of a plurality of cells, wherein the binary mask separates foreground cells from a background; classifying each of the cell regions of the binary mask into single cell regions, small cluster regions, and large cluster regions; performing, on each of the small cluster regions, a segmentation based on a contour shape of the small cluster region; performing, on each of the large cluster regions, a segmentation based on a texture in the large cluster regions; and outputting an image with cell boundaries.

### CROSS-REFERENCES TO RELATED APPLICATIONS

This application claims priority to U.S. Provisional Patent Application Ser. No. 62/235,076, filed on Sep. 30, 2015, the entire content of which is incorporated herein by reference.

### FIELD OF THE INVENTION

The present disclosure relates to a method and system for automated analysis of cell images, and more particularly for a method and system for automated cell segmentation for microscopic cell images, which can be categorized into single cells, small clusters, and large clusters, and wherein cell boundaries can be extracted from the cell images.

### BACKGROUND OF THE INVENTION

In the biomedical imaging domain, segmenting the touching cell nuclei can be a very important step in image analysis. Although there are methods and systems, which perform cell segmentation, these systems do not provide a solution for different clustering types of cells.

### SUMMARY OF THE INVENTION

In consideration of the above issues, it would be desirable to have a system and method for the cell segmentation, for example, of microscopy cell images by first categorizing them into single cells, small clusters, and larger clusters followed by segmenting the small and larger clusters, for example, by different methods.

In accordance with an exemplary embodiment, a method is disclosed for cell segmentation, the method comprising: generating a binary mask from an input image of a plurality of cells, wherein the binary mask separates foreground cells from a background; classifying each of the cell regions of the binary mask into single cell regions, small cluster regions, and large cluster regions; performing, on each of the small cluster regions, a segmentation based on a contour shape of the small cluster region; performing, on each of the large cluster regions, a segmentation based on a texture in the large cluster regions; and outputting an image with cell boundaries.

In accordance with an exemplary embodiment, a non-transitory computer readable medium containing a computer program storing computer readable code for cell segmentation is disclosed, the program being executable by a computer to cause the computer to perform a process comprising: generating a binary mask from an input image of a plurality of cells, wherein the binary mask separates foreground cells from a background; classifying each of the cell regions of the binary mask into single cell regions, small cluster regions, and large cluster regions; performing, on each of the small cluster regions, a segmentation based on a contour shape of the small cluster region; performing, on each of the large cluster regions, a segmentation based on a texture in the large cluster region; and outputting an image with cell boundaries.

In accordance with an exemplary embodiment, a system is disclosed for cell segmentation, the system comprising: an input module configured to generate an input image of a plurality of cells; at least one module configured to process the input image of the plurality of cells to produce a cell count for the input image, the at least one module including a processor configured to: generate a binary mask from an input image of a plurality of cells, wherein the binary mask separates foreground cells from a background; classify each of the cell regions of the binary mask into single cell regions, small cluster regions, and large cluster regions; perform, on each of the small cluster regions, a segmentation based on a contour shape of the small cluster region; perform, on each of the large cluster regions, a segmentation based on a texture in the large cluster region; and output an image with cell boundaries; and a display for displaying the cell count for the output image, wherein the cell count includes: for the single cells regions, a total number of cells based on total connected components from the binary mask; for the small cluster regions, performing a morphological erosion and/or dilation on the image, which has segmentation boundaries overlaid on the binary mask to separate individual cells and a count of connected components; and for the large cluster regions, a total number of large clusters labels from a local maximum clustering algorithm.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of a plurality of different cell types, which can be analyzed and processed in accordance with an exemplary embodiment.

FIG. 2 is a diagram of a system for automatic cell segmentation in accordance with an exemplary embodiment.

FIG. 3A is an illustration of a sample input in accordance with an exemplary embodiment.

FIG. 3B is an illustration of a generated mask in accordance with an exemplary embodiment.

FIG. 4 is a block diagram of a cell category classification system in accordance with an exemplary embodiment.

FIG. 5 is an illustration of an example of a result from a concavity point detection overlay with manually highlighted regions for a single cell, a small cluster, and a large cluster region in accordance with an exemplary embodiment.

FIG. 6 is an illustration of an example of an output from the cell region category classification.

FIG. 7 is a flow chart for boundary and variance based segmentation in accordance with an exemplary embodiment.

FIG. 8A is an illustration of an original image in accordance with exemplary embodiment.

FIG. 8B is an illustration of a corresponding variance image in accordance with an exemplary embodiment.

FIG. 9A is an illustration of a valid pair showing a method differentiating between the valid pair and the invalid pair in accordance with an exemplary embodiment.

FIG. 9B is an illustration of an invalid pair showing a method differentiating between the valid pair and the invalid pair in accordance with an exemplary embodiment.

FIG. 10 is an illustration of a most likely defect pair, a less likely defect pair, and an invalid defect pair in accordance with an exemplary embodiment.

FIG. 11 is an illustration of a system and method for finding a second defect to form a valid pair in accordance with an exemplary embodiment.

FIG. 12 is an illustration of an example of an extraction and a rotation of a region of interest (ROI).

FIG. 13 is an illustration of exemplary samples or results from a boundary-variance segmentation.

FIG. 14 is a flowchart showing a generalized Laplacian of Gaussian (gLoG) filtering based segmentation in accordance with an exemplary embodiment.

FIGS. 15A and 15B are illustrations of a sample response surface as an image and as a surface plot, respectively.

FIG. 16 is an illustration of intermediate results from a local-maxima clustering in accordance with an exemplary embodiment.

FIG. 17 is an illustration of results of segmented cell boundaries.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

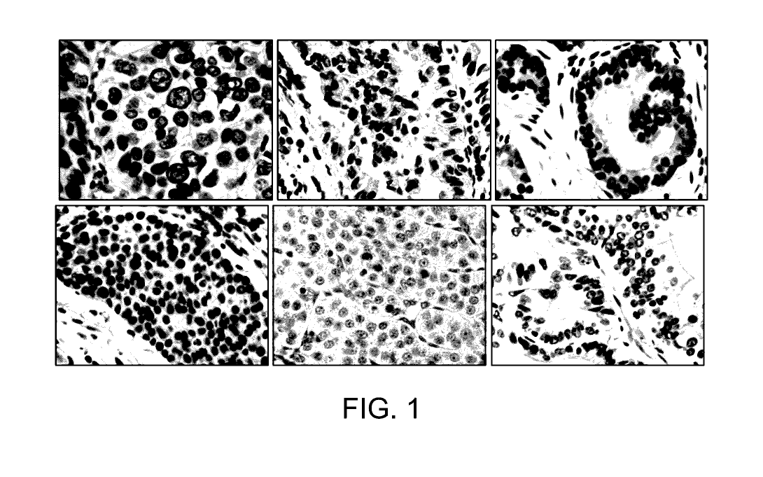

In accordance with an exemplary embodiment, unlike many other methods, a system and method are disclosed, which can be suitable for different sizes of cells present in a single image, for example, irrespective of the cell size (small or large), and which can extract the cell boundaries. FIG. 1 illustrates various kinds of cell images, which can be analyzed and processed in accordance with the systems and methods as disclosed herein.

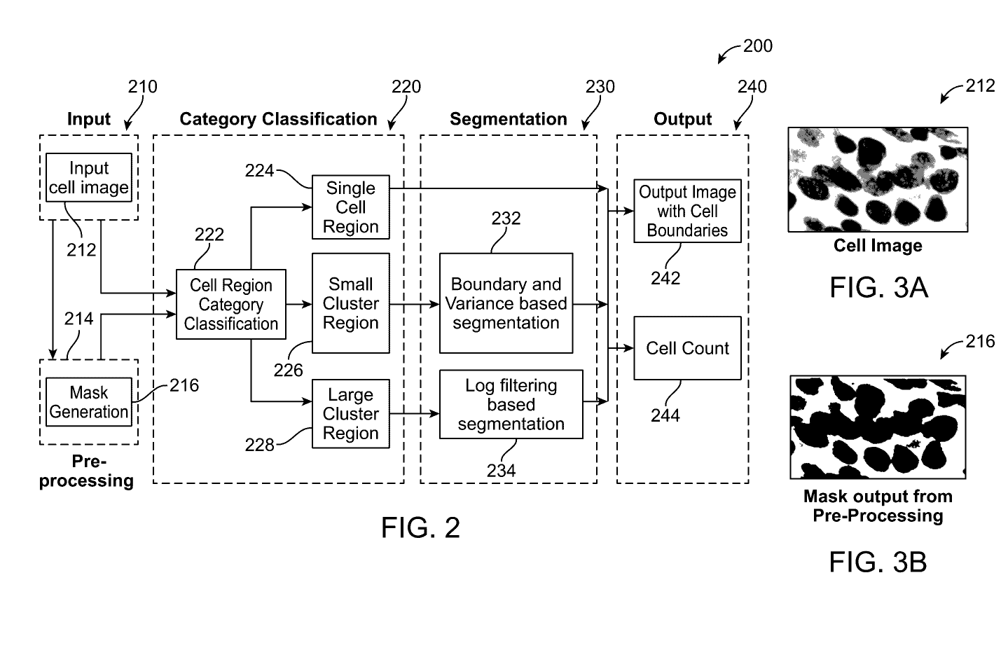

FIG. 2 shows a block diagram for a system 200 for cell segmentation in accordance with an exemplary embodiment. As shown in FIG. 2, the system 200 can include an input module 210, a pre-processing module 214, a category classification module 220, a segmentation module 230, and an output module 240. In accordance with an exemplary embodiment, the input 212, for example, can be a cell image, for example, a contrast stretched cell image obtained from a microscope. In accordance with an exemplary embodiment, the segmentation module 230 can include a boundary and variance based segmentation module 232 and a LoG (Laplacian of Gaussian) filtering based segmentation module 234. The output 240 can include output images with cell boundaries 242 and/or cell count 244.

In accordance with an exemplary embodiment, the input module 210, the pre-processing module 214, the category classification module 220, the segmentation module 230, and the output module 240 can include one or more computer or processing devices having a memory, a processor, an operating system and/or software and/or an optional graphical user interface (GUI) and/or display. In accordance with an exemplary embodiment, for example, each of the modules 210, 214, 220, 230, 240 can be combined in one computer device, for example, a standalone computer, or can be contained within one or more computer devices, wherein each of the one or more computer devices has a memory, a processor, an operating system and/or software, and a graphical user interface (GUI) or display. For example, a graphical user interface can be used to display the cell images and/or cell count as disclosed herein.

### Pre-Processing Module:

In accordance with an exemplary embodiment, the pre-processing module 214 can perform binary mask 216 on the inputted cell images, which separates the foreground cells from the background. In accordance with an exemplary embodiment, the generated mask (or binary mask) can be generated using different methods, for example, thresholding, k-mean clustering followed by thresholding, and/or a machine learning method. FIGS. 3A and 3b are illustrations of the input image 212 and corresponding generated mask 216 using the pre-processing module 214.

### Category Classification:

In accordance with an exemplary embodiment, using the input mask 216, the category classification module 220 classifies the cell region components 222 into one of the 3 following categories.
1. Single cells 224
2. Small Cluster Regions 226
3. Large cluster Regions 228

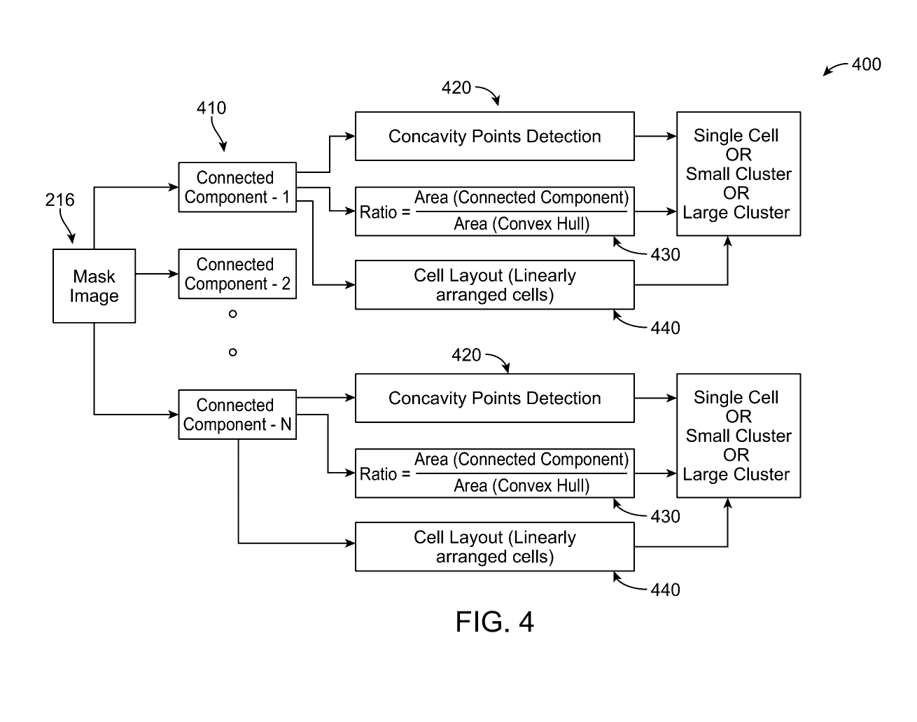

FIG. 4 is a block diagram of a cell category classification system 400 in accordance with an exemplary embodiment. As shown in FIG. 4, for each closed contour present in the mask image 216, the category classification module 220 detects all the concavity points present in the contour 410 and based on the number of concavity points and a ratio of hull area to the contour area 420, determines if the mask image is a single cell 224, a small cluster region 226, or a large cluster region 228.

In accordance with an exemplary embodiment, for example, the concavity points can be detected based on the following algorithm.
Approximate the contour by choosing every n^{th} point from contour. The value n can be determined based on the amount of noise present in the contour boundary.
For each point X with neighbors Y and Z, calculate the cross-product of vectors XY and XZ.
If (crossProduct(XY,XZ)<0) and (Angle(XY,XZ)<threshold) then X is a concavity point.
Once the concavity points are detected, for example, in accordance with an exemplary embodiment, one or more constraints can be added like depth or distance from the hull, minimum distance between 2 possible concavity points etc.

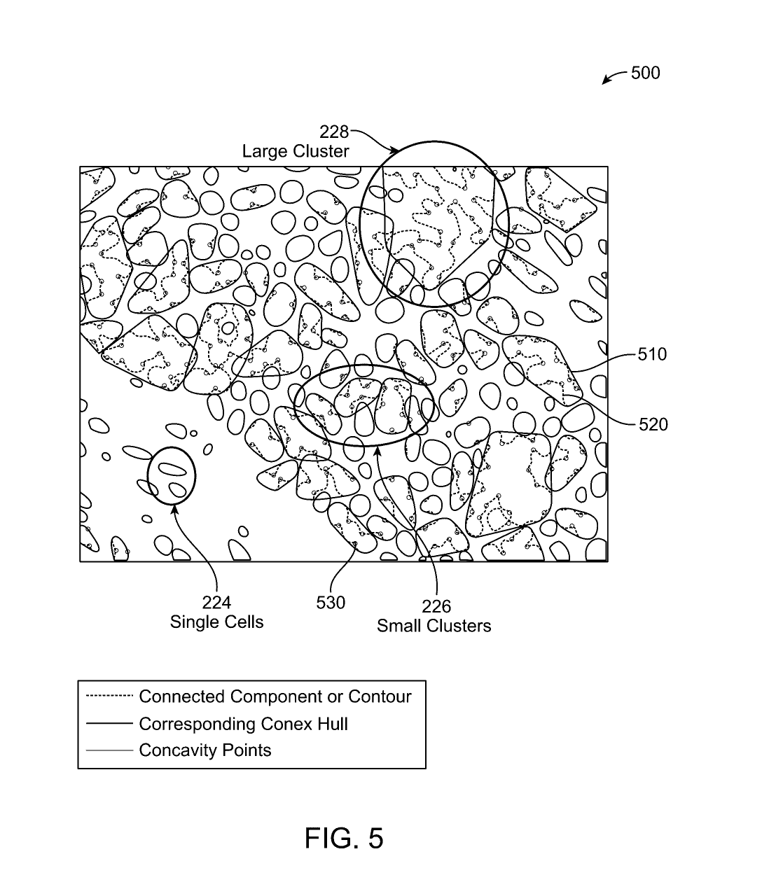

FIG. 5 is an illustration of an example of the output 500 from a concavity points detection as disclosed above, which displays the contours 510, convex Hull of the contour 520, and detected concavity points 530. In addition, as shown in FIG. 5, the output 500 can include single cells 224, small cluster regions 226, and large cluster regions 228.

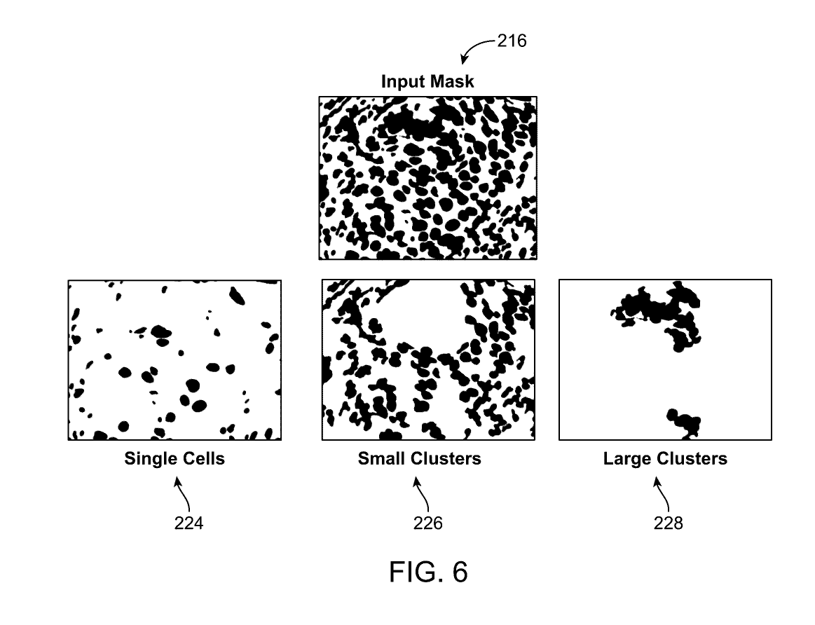

In accordance with an exemplary embodiment, once the convex hull and concavity points are detected, the contours can be separated as shown in FIG. 6 as single cells 224, small cluster regions 226, or large cluster regions 228, for example, based on the following 3 features (FIG. 4):
Number of concavity Points in a contour 420
Ratio of Contour_Area/Hull_Area 430
Layout or linear arrangement of cells 440, which includes disqualifying the clusters, which are densely packed, for which concavity Points information inside the mask cannot be detected

### Segmentation:

### Boundary and Variance Based Segmentation for Small Clusters:

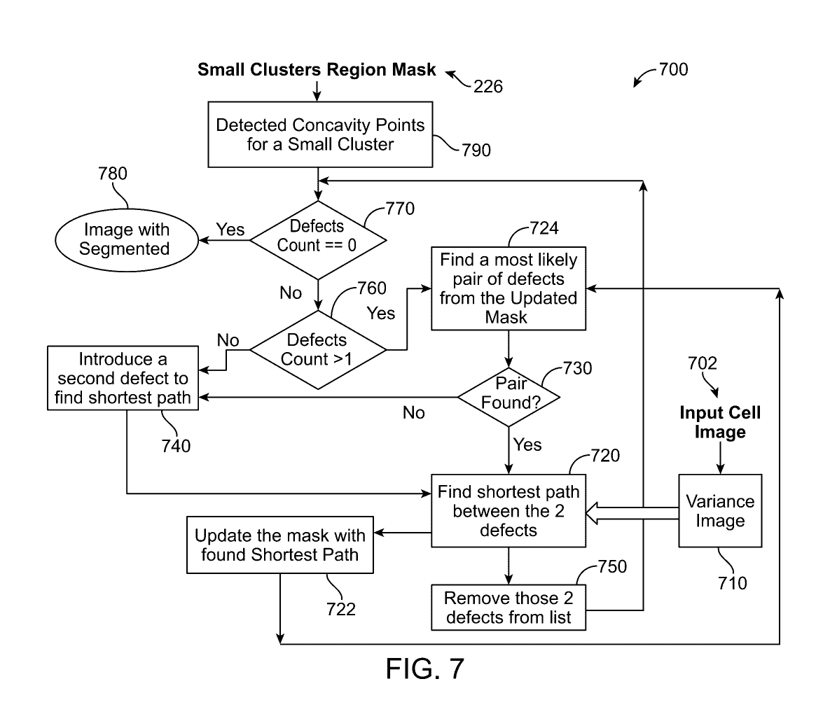

In accordance with an exemplary embodiment, for segmenting small cluster regions 226, a method is disclosed, which uses the boundary shape information as well as variance image derived from image intensities. FIG. 7 is a flow chart 700 for boundary and variance based segmentation in accordance with an exemplary embodiment.

### Variance Image:

In accordance with an exemplary embodiment, in step 710, the input contrast stretched image 702 is received a segmentation module 232, which generates a variance image from the input image 702. In accordance with an exemplary embodiment, the reason of using edge variance image can be, in this image, the edges are more prominent compared to using the actual image, and thus, the chances of finding the correct shortest path are higher. The edge variance is a measure to estimate the strength of edge in a local region.

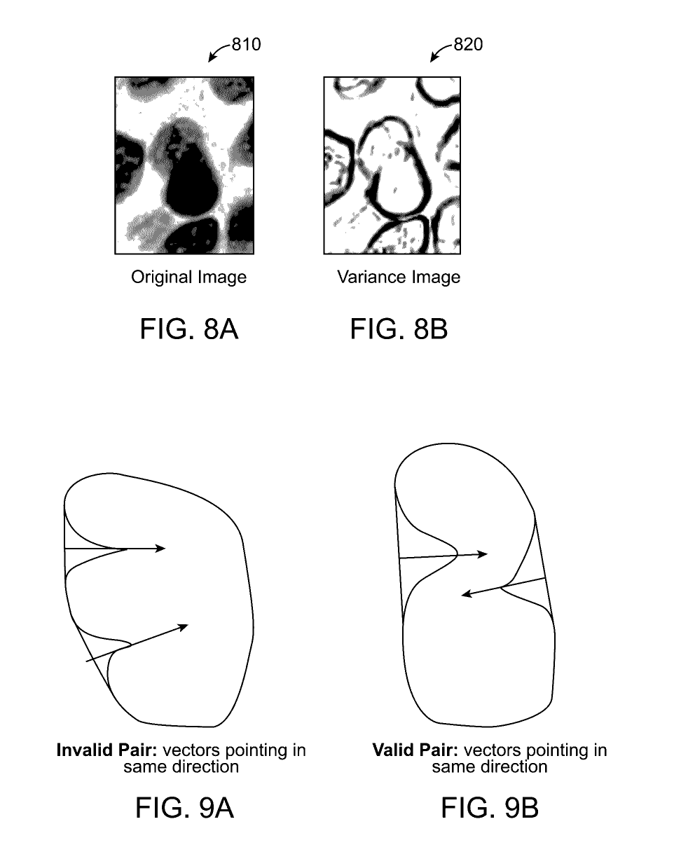

In accordance with an exemplary embodiment, the following filter can be used to generate edge variance image:

$$Var ( {I}_{c} ) = {\sum }_{i ∈ N , i \neq c} w \times exp ( \frac{- ( {I}_{i} - {I}_{c} )}{2 {σ}^{2}} )$$

Where N is a 3×3 neighborhood system, I_{c} is the intensity of the center pixel in N, Iᵢ is the intensity of pixel i in N; w is inversed distance between a pixel i to the center pixel c. FIGS. 8A and 8B illustrate an example of an input image 810 and its corresponding variance image 820, respectively.

### Finding the Most-Likely Pair of Defects:

When the number of defects is more than 1, the most likely pair of defects for which a segmentation boundary can be found. In accordance with an exemplary embodiment, in step 720, the Euclidean distance between each pair of defects can be found, and the pair of defects with the smallest distance can be identified in step 730.

In addition, before forming a pair, in step 724, a test can be performed to check if both the defects are not on the “same side” of the contour. For example, FIGS. 9A and 9B are illustrations of a sample valid pair of defects 910 and an invalid pair of defects 920, respectively, showing how to differentiate between a valid pair and an invalid pair, and which shows how the most-likely pair from the multiple defects can be found. In accordance with an exemplary embodiment, for example, for valid pairs (FIG. 9B), the vectors from the defect and its projection on the hull will be pointing in an opposite direction, while for the invalid defects (FIG. 9A), the vectors will point in the same direction. In step 750, if the defect is not found to be the shortest path, the two points of the pair can be removed from the list.

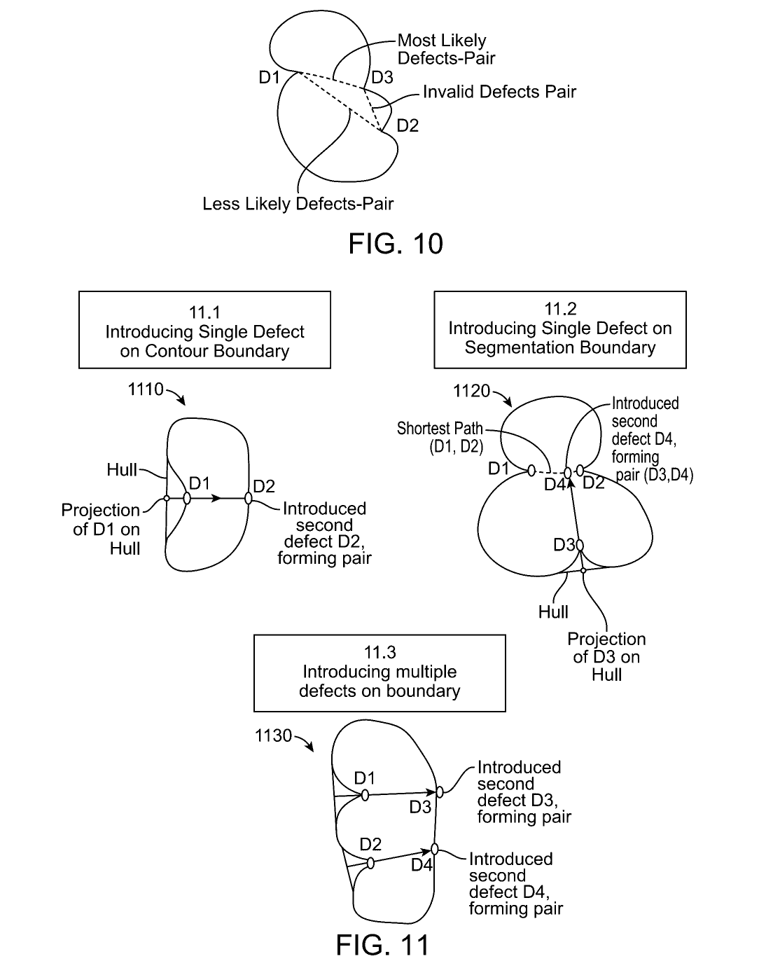

For example, as shown in FIG. 10, even though distance (D2, D3) is less than distance (D1, D3); (D2, D3) are not selected as a pair because they are an “invalid” defect pair. From pair (D1, D3) and pair (D1, D2), in step 730, for example, the most likely pair is chosen as pair (D1, D3), since its Euclidean distance is smallest among the pairs (D1, D3) and (D1, D2).

### Introducing Second Defect Point:

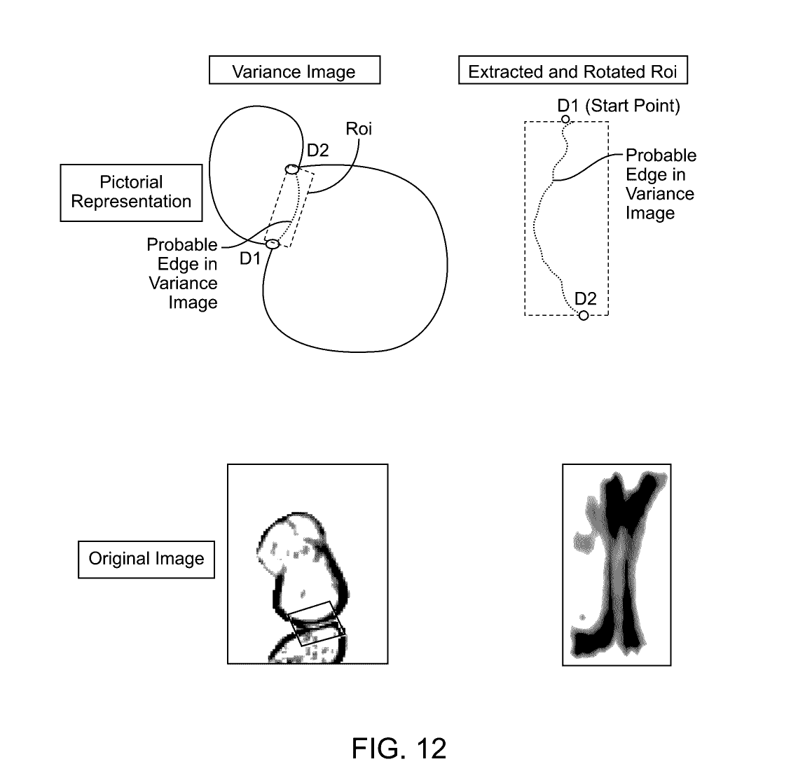

In accordance with an exemplary embodiment, a second defect in the pair can be introduced in step 740, in order to find shortest path between two defects.
Only single defect remaining 1110, 1120 (for example, FIG. 11, case 11.1 and 11.2); or
All the defects present are on the “same” side of contour and no valid pair is present 1130 (for example, FIG. 11, case 11.3).

In accordance with an exemplary embodiment, the second defect is a point on the boundary (contour boundary or segmentation boundary) on the line formed by a defect point and its projection on its hull line. FIG. 11 shows exemplary embodiments of how the second defect can be found. For example, in case 11.1, a single boundary defect D2 can be introduced on a contour boundary, which form a pair (D1, D2). Alternatively, for example, in case 11.2, a single defect D4, can be introduced on a segmentation boundary forming a pair (D3, D4). In case 11.3, multiple defections D3, D4, can be introduced forming pairs (D1, D3), and (D2, D4), respectively.

### Finding Shortest Path Between Two Defects:

In accordance with an exemplary embodiment, once a valid defect pair is found, a shortest path algorithm can be used to find a path between the two defects 720, which follows the actual edge between the two defects.

In accordance with an exemplary embodiment, as shown in FIG. 12, the region of interest (ROI) can be extracted from the image's variance image to find the shortest path. The region of interest (ROI) can be rotated in such a way the orientation of the region of interest is vertical, and the start of shortest path (one of the defects) is in the center of the rectangle.

FIG. 12 is an illustration of an example of an extraction and rotation of a region of interest (ROI). Once the ROI is extracted, the shortest path algorithm starts from the start point, and traverses on the next layer, in this case, the next row to find the next probable point in the path. From the next layer, whichever point makes the cost of the path the lowest, can be selected as the next point in the path.

The path P can be defined as a sequences of points (p₁, p₂, . . . , pᵢ, . . . , pₘ), wherein p₁ is always a defect point. In addition, the second defect is a last point in the path P, since a complete path reaching from one defect to another defect is desired, pᵢ is i^{th} layer's point in path P.

The cost function can be defined as

$$C ( P ) = {\sum }_{i = 1}^{m} {C}_{0} ( i , {p}_{i} ) + {\sum }_{i = 1}^{m - 1} {C}_{1} ( i , {p}_{i} , {p}_{i + 1} )$$

where C₀ is the object term and C₁ is constraint term, for example, C₁ will decide how much farther a next point (pᵢ₊₁) can be from the current point (pᵢ), column wise.

$${C}_{1} ( i , {p}_{i} , {p}_{i + 1} ) = \{ \begin{matrix}0 & if \vert {p}_{i} - {p}_{i + 1} \vert \leq 1 \\ ∞ & otherwise\end{matrix}$$

C₀ is calculated from the intensity value of the variance image at i^{th} layer and the previous point's cost value. The point pᵢ₊₁ can be selected based on the lowest cost and added to the existing path, P.

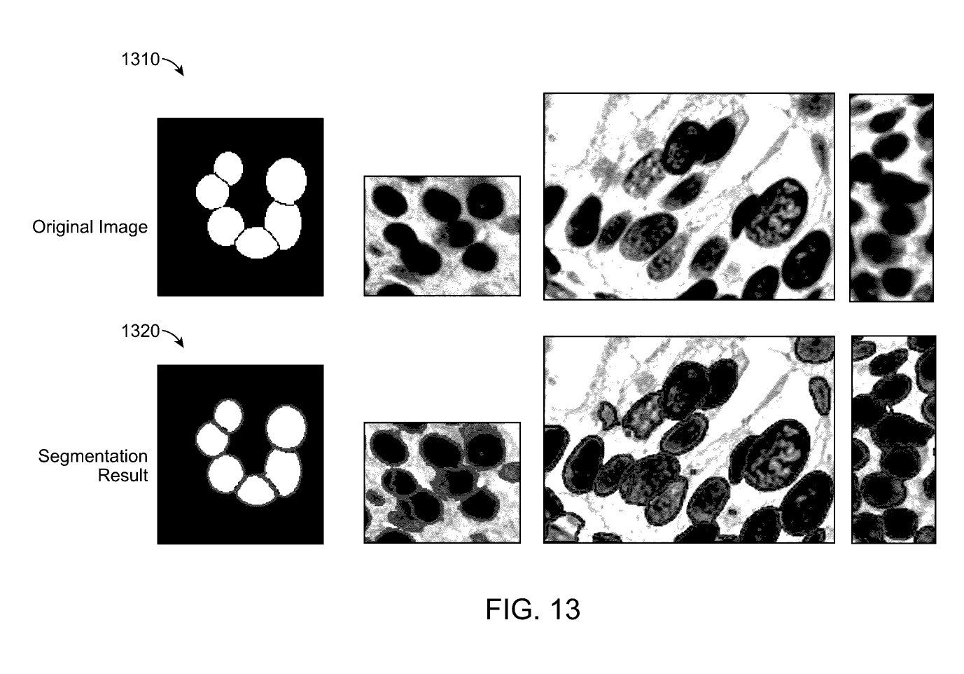

FIG. 13 is an illustration of an example of results from boundary-variance segmentation, comparing the original image 1310 to the segmentation result 1320, and the results generated from finding most-likely defect pairs and the shortest path between the most likely defect pairs.

In addition, since the boundaries separate the cells, an erosion on the image can be performed which has segmentation boundaries overlaid on the mask, which can separate the individual cells, and the count of connected-component can provide a cell count.

### LoG (Laplacian of Gaussian) Filtering Based Segmentation for Large Clusters:

In accordance with an exemplary embodiment, once the large cluster region 228 is detected from the mask image, the large cluster region 228 is sent to the segmentation module for large clusters. For the cell segmentation of large cluster region, a segmentation based on texture, for example, a blob detection method, such as a generalized Laplacian of Gaussian (gLoG), can be used.

LoG Filtering with Multiple Scales:

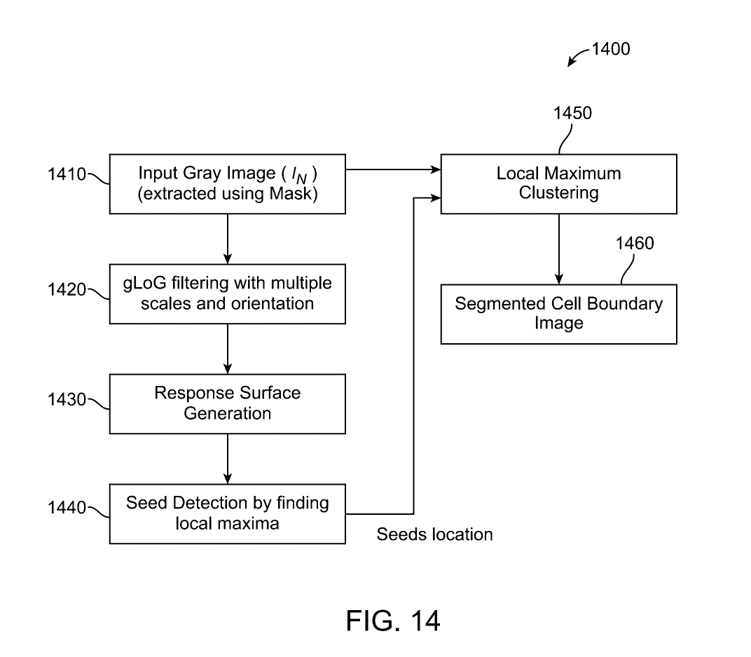

In accordance with an exemplary embodiment, a gLoG filtering based segmentation is shown in FIG. 14. In accordance with an exemplary embodiment, in step 1410, the cell segmentation boundaries can be found by extracting the input grayscale image using the input mask such that only cell nuclei to be processed and no background is present, which can be called image I_{N}.

In step 1420, the image I_{N}, is processed using a Laplacian of Gaussian (LoG) filtering with multiple scales and orientation. The LoG filter can be defined as follows.

$$LoG ( x , y ; σ ) = \frac{{\partial }^{2} G ( x , y ; σ )}{\partial {x}^{2}} + \frac{{\partial }^{2} G ( x , y ; σ )}{\partial {y}^{2}} \qquad ( 1 )$$

where, σ is scale value or size of the filters and G(x,y; σ) is a Gaussian filter with size σ and 0 mean. For multiple scales, σ the input image, I_{N} is filtered. In addition, to normalize the response for multiple scale values, σ

LoGₙₒᵣₘ(x,y; σ)=σ²*LoG(x,y; σ), where σ=[σₘᵢₙ, . . . , σₘₐₓ] (2)

which filter can produce a peak response with radius, r=σ*√2

However, because the above LoG is only rotational symmetric, for example, the σ is set to be equal for both x and y coordinates, the above equation is limited in detecting cell nuclei with general elliptical shapes. Thus, in accordance with an exemplary embodiment, to detect general elliptical cell nuclei, a generalized Laplacian of Gaussian (gLoG) filter can be used, wherein gLoG(x, y; σₓ, σ_{y}, θ) replaces LoG(x, y; σ) in equation (2).

A general form of Gaussian kernel can be written as

G(x,y)=C·e^{-(a(x-x}^{₀}⁾^{²}^{+2b(x-x}^{₀}^{)(y-y}^{₀}^{)+c(y-y}^{₀}⁾^{²}⁾ (3)

where C is a normalization factor, and x₀ and y₀ are kernel center; a, b and c are the coefficients that describe the shape, orientation of the kernel, and can be derived by the means of σₓ, σ_{y}, and θ as follows

$$a = \frac{{cos}^{2} θ}{2 {σ}_{x}^{2}} + \frac{{sin}^{2} θ}{2 {σ}_{y}^{2}}$$

$$c = \frac{sin 2 θ}{2 {σ}_{x}^{2}} + \frac{sin 2 θ}{2 {σ}_{y}^{2}}$$

$$b = \frac{{cos}^{2} θ}{4 {σ}_{x}^{2}} + \frac{{sin}^{2} θ}{4 {σ}_{y}^{2}}$$

In accordance with an exemplary embodiment, to be simplified, x₀ and y₀ can be zero. Therefore, the 5-D Gaussian kernel turns into

G(x,y,σₓ,σ_{y},θ)=C·e^{-(ax}^{²}^{+2bxy+cy}^{²}⁾

In accordance with an exemplary embodiment, the generalized Laplacian of Gaussian (gLoG) can be written as:

$$gLoG ( x , y ; {σ}_{x} , {σ}_{y} , θ ) = \frac{{\partial }^{2} G ( x , y ; {σ}_{x} , {σ}_{y} , θ )}{\partial {x}^{2}} + \frac{{\partial }^{2} G ( x , y ; {σ}_{x} , {σ}_{y} , θ )}{\partial {y}^{2}} \qquad ( 4 )$$

To normalize the response for multiple scales and orientations, Equation (2) can be rewritten as a general form

gLoGₙₒᵣₘ(x,y; σ)=σₓσ_{y}*gLog(x,y; σₓ,σ_{y},θ)

where σₓ ∈ [σₓ^{min}, . . . , σₓ^{max}], σ_{y} ∈ [σ_{y}^{min}, . . . , σ_{y}^{min}] and θ ∈ [0,45°,90°,135°].

### Response Surface:

In step 1430, once the multiple filtered images for different scales have been obtained, using the Distance Map, D_{N} as constraint factor, a single response surface can be obtained by combining these filtering results into single image expressed by following equation. Accordingly, the response for a generalized LoG can be written as

Rₙ(x,y)=argmax_{σ}_{ₓ}_{,σ}_{_{y}}_{,θ}{gLoGₙₒᵣₘ(x,y,σₓ,σ_{y},θ)*L_{N}(x,y)} (5)

Where σₓ ∈ [σₓ^{min}, σₓ^{max}], σ_{y} ∈ [σ_{y}^{min}, σ_{y}^{max}], θ=[0, . . . , 135°] and

σₓ^{max}=max{σₓ^{min},min{σₓ^{max},2D_{N(x,y)}}}, (6)

σ_{y}^{max}=max{σ_{y}^{min},min{σ_{y}^{max},2D_{N(x,y)}}} (7)

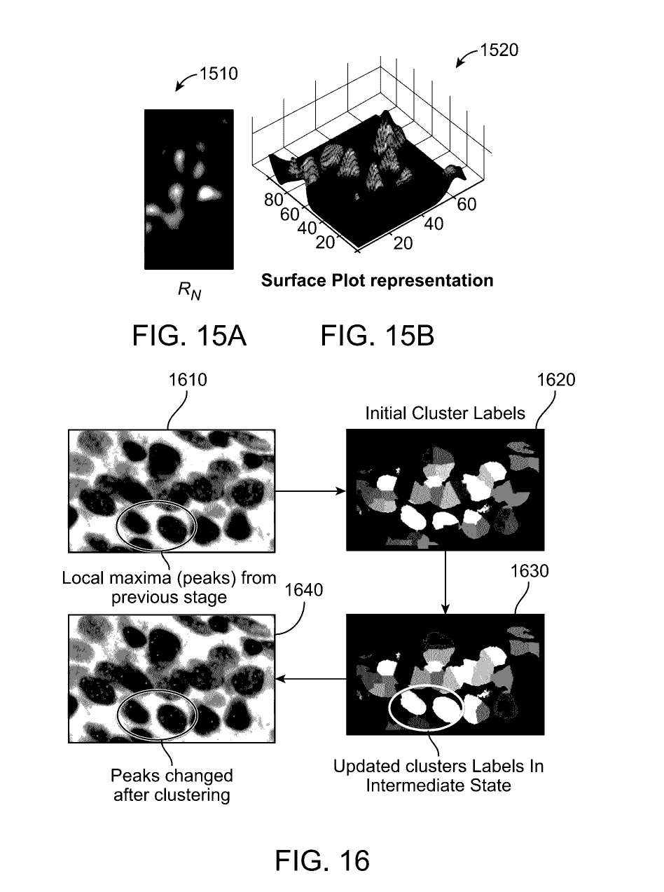

FIGS. 15A and 15B are illustrations of a sample response surface from step 1430 shown as an image 1510 and as a surface plot 1520, respectively.

### Seed Detection:

From the response surface, in step 1440, R_{N} the local maxima can be detected to generate the initial seeds, which are the center of the nuclei or at least they appear to be the center of the nuclei. The initial seed locations can be passed to a local-maximum based clustering algorithm to refine the clustering of cell pixels for more accurate cell boundaries.

### Local Maximum Clustering:

In accordance with an exemplary embodiment, in step 1450, a local maximum clustering on the input grayscale image can be performed to help ensure assignment of pixels to the cluster centers or the seed points.

The resolution parameter, r defines a region of 2r×2r around each pixel to search for the nearest and closest matching seed point. The local maximum clustering algorithm can be described in the following steps.
i. For each seed point, assign the pixels in its neighborhood 2r×2r same cluster label as the seed point, if the intensity difference between the pixel and cluster center(seed point) is less than threshold
ii. Combine the 2 clusters into 1 cluster if
   The distance between two seed points is less than resolution parameter, r
   The intensity difference between the two seed points is less than threshold
iii. Assign the cluster labels of merged clusters as same and find a new seed, which is maximum from both the seed points
iv. If there is change in the seed points, repeat the steps (ii) and (iii)

In accordance with an exemplary embodiment, after the local maximum clustering the unwanted extra seeds will be removed and pixels will be assigned proper cluster label in step 1460. Examples, of the intermediate results are illustrated in FIG. 16. As shown in FIG. 16, the local maxima (peaks) from the previous stage 1610, the initial cluster labels 1620, the updated cluster labels in an intermediate state 1630, and peak changes after clustering 1640.

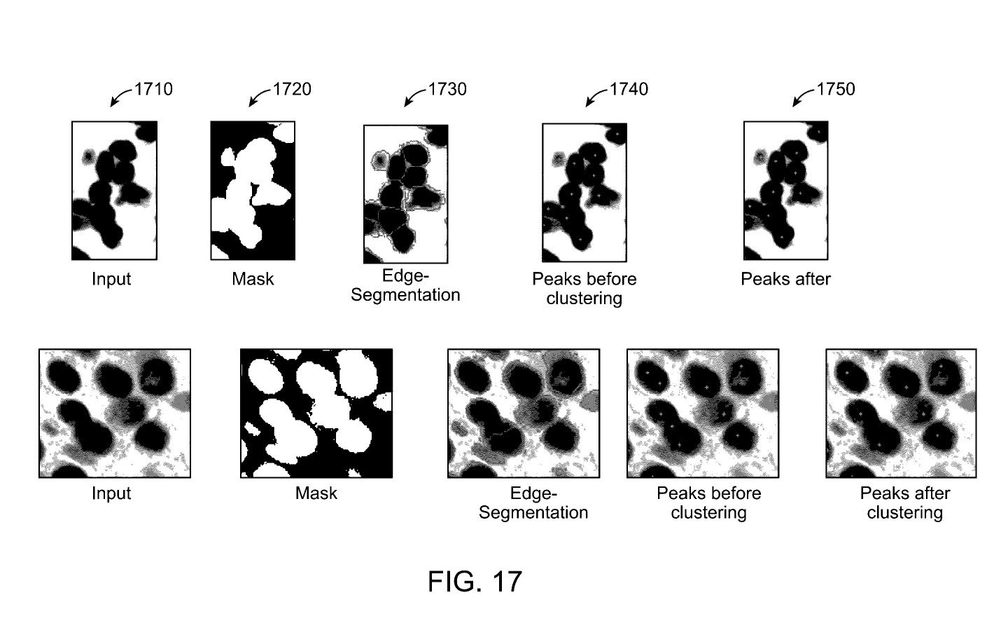

The clusters boundaries are the cell boundaries and thus, the cell segmentation result can be seen, for example, in FIG. 17. As shown in FIG. 17, the process can include the following stages: input 1710, mask 1720, edge-segmentation 1730, peaks before clustering 1740, and peaks after clustering 1750.

### Output Cell Count:

### Single Cells Image Cell Counting:

For single cells image (or single cell regions), in accordance with an exemplary embodiment, the total number of cells can be derived based on the total connected-components from the binary mask.

### Small Cluster Region Cell Counting:

Since a segmentation based on a contour shape of the small cluster region can be used, for example, a boundary-variance based segmentation for small clusters, and wherein the segmentation boundaries clearly separate the cells. In accordance with an exemplary embodiment, performing a morphological erosion/dilation on the image, which has segmentation boundaries overlaid on mask, separates the individual cells and thus the count of connected-components can give a cell count.

### LoG Filtering Based Segmentation for Large Cluster Region Counting:

LoG filtering detects the nuclei of cells in the large cluster of cells and the detected nuclei can be further used as seeds for any region segmentation methods, such as watershed segmentation method or level set segmentation method, which will separate the individual cells from the cluster and thus the count of connected-components can give a cell count.

The total number of clusters labeled gives the count of total cells. Thus, in accordance with an exemplary embodiment,

Cell count=Total number of connected−component labels from Single_{Cell} mask+Total number of connected component labels from modified Small Clusters mask+Total number of cluster labels from the local maximum clustering algorithm

where, modified Small Clusters mask=Morphology(Small Clusters Mask+segmentation boundaries).

In accordance with an exemplary embodiment, a non-transitory computer readable medium is disclosed containing a computer program storing computer readable code for cell segmentation, the program being executable by a computer to cause the computer to perform a process comprising: generating a binary mask from an input image of a plurality of cells, wherein the binary mask separates foreground cells from a background; classifying each of the cell regions of the binary mask into single cell regions, small cluster regions, and large cluster regions; performing, on each of the small cluster regions, a segmentation based on a contour shape of the small cluster region; performing, on each of the large cluster regions, a segmentation based on a texture in the large cluster region; and outputting an image with cell boundaries.

The computer readable recording medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for cell segmentation, the method comprising:
generating a binary mask from an input image of a plurality of cells, wherein the binary mask separates foreground cells from a background;
classifying each of the cell regions of the binary mask into single cell regions, small cluster regions, and large cluster regions;
performing, on each of the small cluster regions, a segmentation based on a contour shape of the small cluster region;
performing, on each of the large cluster regions, a segmentation based on a texture in the large cluster regions; and
outputting an image with cell boundaries.

2. The method according to claim 1, comprising:
generating the binary mask with a thresholding, a k-mean clustering followed by a thresholding, or a machine learning method.

3. The method according to claim 1, comprising:
detecting for each closed contour in the binary mask, each of the concavity points present in the contour and based on a number of concavity points calculating a ratio of hull area to contour area; and
classifying each of the closed contours as one of the following classifications: the single cell region, the small cluster region, or the large cluster region.

4. The method according to claim 3, comprising:
disqualifying clusters of cells which do not include concavity points inside the binary mask.

5. The method according to claim 3, comprising:
generating a variance image for each of the closed contours classified as the small cluster regions, the variance image comprising:
generating an edge variance image;
finding a most likely pair of defects when a number of defects is greater than one, the most likely pair of defects includes:
finding a Euclidean distance between each pair of defects;
if both defects are on the same side, identifying the pair of defects as an invalid pair; and
if the defects are on opposite sides, identifying the pair of defects having a smallest distance between the pair of defects as the most likely pair of defects, the most likely pair of defects corresponding to two or more cells.

6. The method according to claim 5, comprising:
introducing a second defect in the pair of defects for a single remaining defect or for remaining defects, which are on a same side of the contour and no valid pair is identified, the second defect being a point on a boundary on a line formed by a first defect point and a projection of the first defect's hull line; and
applying a shortest path algorithm to a path between the first defect point and the second defect point, the shortest path algorithm comprising:
extracting a region of interest;
vertically orientating the region of interest;
traversing the region of interest from a starting point and finding a next probable point in a path,
selecting the next probably point in the path, which makes a smallest cost of the path, wherein the path is defined as (p₁, p₂, . . . , pᵢ, . . . , pₘ), wherein p₁ is always a defect point, and the second defect is a last point in the path P, and pᵢ is i^{th} layer's point in path P.

7. The method according to claim 6, wherein the cost of the path is defined as a cost function, and wherein the cost function is:
$$C ( P ) = {\sum }_{i = 1}^{m} {C}_{0} ( i , {p}_{i} ) + {\sum }_{i = 1}^{m - 1} {C}_{1} ( i , {p}_{i} , {p}_{i + 1} )$$
where C₀ is the object term and C₁ is constraint term, C₁ will decide how much farther a next point (pᵢ₊₁) is from a current point (pᵢ), column wise.
$${C}_{1} ( i , {p}_{i} , {p}_{i + 1} ) = \{ \begin{matrix}0 & if \vert {p}_{i} - {p}_{i + 1} \vert \leq 1 \\ ∞ & otherwise\end{matrix}$$
wherein C₀ is calculated from an intensity value of the variance image at i^{th} layer and a previous point's cost value, and the point pᵢ₊₁ is selected based on a lowest cost and added to an existing path, P.

8. The method according to claim 1, wherein the segmentation based on the texture in the large cluster regions is a generalized Laplacian of Gaussian (gLoG) filtering based segmentation, the gLoG filtering based segmentation comprising:
inputting gray images extracted from the binary mask to generate cell segmentation boundaries of cell nuclei;
filtering the cell segmentation boundaries of the cell nuclei with a gLoG filter with one or more scales and orientations;
generating a response surface from the filtered cell segmentation boundaries of the cell nuclei using a distance map;
detecting a local maxima from the response surface to generate a plurality of seed points; and
for each of the plurality of seed points, applying a resolution algorithm.

9. The method according to claim 1, comprising:
generating a cell count, wherein:
for the single cell regions, a total number of cells based on total connected components from the binary mask;
for the small cluster regions, performing a morphological erosion and/or dilation on the image, which has segmentation boundaries overlaid on the binary mask to separate individual cells and a count of connected components; and
for the large cluster regions, a total number of large clusters labels from a local maximum clustering algorithm.

10. A non-transitory computer readable medium containing a computer program storing computer readable code for cell segmentation, the program being executable by a computer to cause the computer to perform a process comprising:
generating a binary mask from an input image of a plurality of cells, wherein the binary mask separates foreground cells from a background;
classifying each of the cell regions of the binary mask into single cell regions, small cluster regions, and large cluster regions;
performing, on each of the small cluster regions, a segmentation based on a contour shape of the small cluster region;
performing, on each of the large cluster regions, a segmentation based on a texture in the large cluster region; and
outputting an image with cell boundaries.

11. The computer readable storage medium according to claim 10, comprising:
generating the binary mask with a thresholding, a k-mean clustering followed by a thresholding, or a machine learning method.

12. The computer readable storage medium according to claim 10, comprising:
detecting for each closed contour in the binary mask, each of the concavity points present in the contour and based on a number of concavity points calculating a ratio of hull area to contour area;
classifying each of the closed contours as one of the following classifications: the single cell region, the small cluster region, or the large cluster region.
disqualifying clusters of cells which do not include concavity points inside the binary mask; and
generating a variance image for each of the closed contours classified as the small cluster regions, the variance image comprising:
generating an edge variance image;
finding a most likely pair of defects when a number of defects is greater than one, the most likely pair of defects comprising:
finding a Euclidean distance between each pair of defects;
if both defects are on the same side, identifying the pair of defects as an invalid pair; and
if the defects are on opposite sides, identifying the pair of defects having a smallest distance between the pair of defects as the most likely pair of defects, the most likely pair of defects corresponding to two or more cells.

13. The computer readable storage medium according to claim 12, comprising:
introducing a second defect in the pair of defects for a single remaining defect or for remaining defects, which are on a same side of the contour and no valid pair is identified, the second defect being a point on a boundary on a line formed by a first defect point and a projection of the first defect's hull line; and
applying a shortest path algorithm to a path between the first defect point and the second defect point, the shortest path algorithm comprising:
extracting a region of interest;
vertically orientating the region of interest;
traversing the region of interest from a starting point and finding a next probable point in a path,
selecting the next probably point in the path, which makes a smallest cost of the path, wherein the path is defined as (p₁, p₂, . . . , pᵢ, . . . , pₘ), wherein p₁ is always a defect point, and the second defect is a last point in the path P, and pᵢ is i^{th} layer's point in path P.

14. The computer readable storage medium according to claim 13, wherein the cost of the path is defined as cost function, and wherein the cost function is:
$$C ( P ) = {\sum }_{i = 1}^{m} {C}_{0} ( i , {p}_{i} ) + {\sum }_{i = 1}^{m - 1} {C}_{1} ( i , {p}_{i} , {p}_{i + 1} )$$
where C₀ is the object term and C₁ is constraint term, C₁ will decide how much farther a next point (pᵢ₊₁) is from a current point (pᵢ), column wise.
$${C}_{1} ( i , {p}_{i} , {p}_{i + 1} ) = \{ \begin{matrix}0 & if \vert {p}_{i} - {p}_{i + 1} \vert \leq 1 \\ ∞ & otherwise\end{matrix}$$
wherein C₀ is calculated from an intensity value of the variance image at i^{th} layer and a previous point's cost value, and the point pᵢ₊₁ is selected based on a lowest cost and added to an existing path, P.

15. The computer readable storage medium according to claim 10, wherein the segmentation based on the texture in the large cluster regions is a generalized Laplacian of Gaussian (gLoG) filtering based segmentation, the gLoG filtering based segmentation comprising:
inputting gray images extracted from the binary mask to generate cell segmentation boundaries of cell nuclei;
filtering the cell segmentation boundaries of the cell nuclei with a gLoG filter with one or more scales and orientations;
generating a response surface from the filtered cell segmentation boundaries of the cell nuclei using a distance map;
detecting a local maxima from the response surface to generate a plurality of seed points; and
for each of the plurality of seed points, applying a resolution algorithm.

16. The computer readable storage medium according to claim 10, comprising:
generating a cell count, wherein:
for the single cell regions, a total number of cells based on total connected components from the binary mask;
for the small cluster regions, performing a morphological erosion and/or dilation on the image, which has segmentation boundaries overlaid on the binary mask to separate individual cells and a count of connected components; and
for the large cluster regions, a total number of large clusters labels from a local maximum clustering algorithm.

17. A system for cell segmentation, the system comprising:
an input module configured to generate an input image of a plurality of cells;
at least one module configured to process the input image of the plurality of cells to produce a cell count for the input image, the at least one module including a processor configured to:
generate a binary mask from an input image of a plurality of cells, wherein the binary mask separates foreground cells from a background;
classify each of the cell regions of the binary mask into single cell regions, small cluster regions, and large cluster regions;
perform, on each of the small cluster regions, a segmentation based on a contour shape of the small cluster region;
perform, on each of the large cluster regions, a segmentation based on a texture in the large cluster region; and
output an image with cell boundaries; and
a display for displaying the cell count for the output image, wherein the cell count comprises:
for the single cells regions, a total number of cells based on total connected components from the binary mask;
for the small cluster regions, performing a morphological erosion and/or dilation on the image, which has segmentation boundaries overlaid on the binary mask to separate individual cells and a count of connected components; and
for the large cluster regions, a total number of large clusters labels from a local maximum clustering algorithm.

18. The system according to claim 17, wherein the processor is configured to:
generate the binary mask with a thresholding, a k-mean clustering followed by a thresholding, or a machine learning method.
detect for each closed contour in the binary mask, each of the concavity points present in the contour and based on a number of concavity points calculating a ratio of hull area to contour area;
classify each of the closed contours as one of the following classifications: the single cell region, the small cluster region, or the large cluster region.
disqualify clusters of cells which do not include concavity points inside the binary mask; and
generate a variance image for each of the closed contours classified as the small cluster regions, the variance image comprising:
generating an edge variance image;
finding a most likely pair of defects when a number of defects is greater than one, the most likely pair of defects comprising:
finding a Euclidean distance between each pair of defects;
if both defects are on the same side, identifying the pair of defects as an invalid pair; and
if the defects are on opposite sides, identifying the pair of defects having a smallest distance between the pair of defects as the most likely pair of defects, the most likely pair of defects corresponding to two or more cells.

19. The system according to claim 18, wherein the processor is configured to:
introduce a second defect in the pair of defects for a single remaining defect or for remaining defects, which are on a same side of the contour and no valid pair is identified, the second defect being a point on a boundary on a line formed by a first defect point and a projection of the first defect's hull line; and
apply a shortest path algorithm to a path between the first defect point and the second defect point, the shortest path algorithm comprising:
extracting a region of interest;
vertically orientating the region of interest;
traversing the region of interest from a starting point and finding a next probable point in a path,
selecting the next probably point in the path, which makes a smallest cost of the path, wherein the path is defined as (p₁, p₂, . . . pᵢ, . . . , pₘ), wherein p₁ is always a defect point, and the second defect is a last point in the path P, and pᵢ is i^{th} layer's point in path P;
wherein the cost of the path is defined as a cost function, and wherein the cost function is:
$$C ( P ) = {\sum }_{i = 1}^{m} {C}_{0} ( i , {p}_{i} ) + {\sum }_{i = 1}^{m - 1} {C}_{1} ( i , {p}_{i} , {p}_{i + 1} )$$
where C₀ is the object term and C₁ is constraint term, C₁ will decide how much farther a next point (pᵢ₊₁) is from a current point (pᵢ), column wise.
$${C}_{1} ( i , {p}_{i} , {p}_{i + 1} ) = \{ \begin{matrix}0 & if \vert {p}_{i} - {p}_{i + 1} \vert \leq 1 \\ ∞ & otherwise\end{matrix}$$
wherein C₀ is calculated from an intensity value of the variance image at i^{th} layer and a previous point's cost value, and the point pᵢ₊₁ is selected based on a lowest cost and added to an existing path, P.

20. The system according to claim 17, wherein the segmentation based on the texture in the large cluster regions is a generalized Laplacian of Gaussian (gLoG) filtering based segmentation, and the processor is configured to:
input gray images extracted from the binary mask to generate cell segmentation boundaries of cell nuclei;
filter the cell segmentation boundaries of the cell nuclei with a gLoG filter with one or more scales and orientations;
generate a response surface from the filtered cell segmentation boundaries of the cell nuclei using a distance map;
detect a local maxima from the response surface to generate a plurality of seed points; and
for each of the plurality of seed points, applying a resolution algorithm.
